(19) United States
(12) Patent Application Publication
(10) Pub. No.: US 2025/0289402 A1
(43) Pub. Date: Sep. 18, 2025

(54) METHOD FOR LIMITING A CONTINUOUS DECELERATION EFFORT OF A CONTINUOUS DECELERATION DEVICE

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/221,379

(22) Filed: May 28, 2025

Related U.S. Application Data
(63) Continuation of application No. PCT/EP2023/083709, filed on Nov. 30, 2023.

(30) Foreign Application Priority Data
Dec. 20, 2022 (DE) 10 2022 134 143.7

(51) Int. Cl. B60T 7/20; B60Q 9/00; B60T 8/17; B60T 8/171; B60T 8/172; B60T 13/58

(52) U.S. Cl. CPC B60T 7/20; B60Q 9/00; B60T 8/1701; B60T 8/171; B60T 8/172; B60T 13/585; B60T 2201/03; B60T 2201/04; B60T 2210/12; B60T 2210/20; B60T 2210/24; B60T 2230/00; B60T 2250/00; B60T 2250/02

(57) ABSTRACT

A method for controlling a vehicle train, having a towing vehicle and at least one trailer vehicle. The towing vehicle includes a continuous deceleration device for performing a continuous deceleration. The method includes the steps: determining a trailer mass of the trailer vehicle in the prevailing vehicle configuration of the vehicle train; determining a towing vehicle trailer mass of the towing vehicle in the prevailing vehicle configuration; determining a mass ratio of the prevailing vehicle configuration based on the trailer mass and the towing vehicle mass; and limiting a maximum permissible continuous deceleration power of the continuous deceleration device based on the mass ratio. A driver assistance system is configured to perform the method. A commercial vehicle includes the driver assistance system. A computer program product is configured to perform the method.

### CROSS-REFERENCE TO RELATED APPLICATIONS

This application is a continuation application of international patent application PCT/EP2023/083709, filed Nov. 30, 2023, designating the United States and claiming priority from German application 10 2022 134 143.7, filed Dec. 20, 2022, and the entire content of both applications is incorporated herein by reference.

### TECHNICAL FIELD

The disclosure relates to a method for controlling a vehicle train, having a towing vehicle and at least one trailer vehicle, wherein the towing vehicle comprises a continuous deceleration device. The continuous deceleration device is provided so as to perform a continuous deceleration of the vehicle train. Moreover, the disclosure relates to a driver assistance system which is configured so as to perform the method, a commercial vehicle and a computer program product.

### BACKGROUND

Due to the great weight, a significant braking power is required in order to slow down a vehicle. Particularly in the case of commercial vehicles, service brakes of the vehicle can reach very high temperatures in certain driving situations, such as long downhill slopes. This is as a result of the fact that classic service brakes are mostly configured as friction brakes which convert kinetic energy of the vehicle into thermal energy. Particularly in the case of long downhill slopes or steep downhill gradients, this can lead to the service brakes of a commercial vehicle reaching temperatures of 400° or more. At such temperatures, their braking efficiency usually drops considerably, so that safe braking of the vehicle can no longer be guaranteed under certain circumstances. Moreover, lengthy continuous use of the friction brakes leads to high brake wear, which in turn leads to high operating costs. For these reasons, commercial vehicles in particular frequently comprise a substantially wear-free continuous deceleration device which is also referred to in specific configurations as a retarder. In this case, the continuous deceleration device frequently operates as a hydrodynamic continuous deceleration device or as an electrodynamic deceleration device which is also referred to as a recuperator. Such a continuous deceleration device brakes the vehicle in a reliable and wear-free manner so that the service brakes of the vehicle are preserved and remain fully operational in emergency situations. For these reasons, continuous deceleration devices are legally prescribed for buses and lorries in many European countries.

A continuous deceleration device directly decelerates only one vehicle part in which it is installed. In particular, a continuous deceleration device only induces brake slip on wheels of an axle on which the continuous deceleration device is arranged. On the other hand, other vehicle parts which do not comprise a continuous deceleration device are not directly influenced by the continuous deceleration device. It is therefore not necessary to transmit a deceleration-inducing braking force from the braked vehicle part to the non-braked vehicle part or from the vehicle part that is independent of the continuous deceleration device. This transmission of braking forces means that vehicle parts not influenced by the continuous deceleration device can cause an instability of the entire vehicle train.

The continuous deceleration device is frequently arranged in a towing vehicle of the vehicle train while corresponding trailer vehicles do not usually comprise a dedicated continuous deceleration device. Since the trailer vehicle and the towing vehicle are generally connected by means of a rigid towing bar, the trailer vehicle cannot drive into the towing vehicle but rather transmits forces to the towing vehicle by means of the tow bar. This can, for example, lead to the vehicle train jack-knifing and/or the towing vehicle being destabilized by the forces acting on the rear. When using a continuous deceleration device in the trailer vehicle, over-braking or an excessive deceleration of the trailer vehicle in comparison to the towing vehicle can also lead to an instability of the trailer vehicle.

In order to avoid this destabilization, it is necessary for the vehicle parts independent of the continuous deceleration device to also produce a deceleration power in a reactive manner by means of their service brakes. Thus, where appropriate, in order to avoid instabilities in dependence upon the continuous deceleration power provided by the continuous deceleration device, a brake slip is additionally applied to the service brakes of axles that are independent of the continuous deceleration device. However, this is provided exclusively in a reactive manner in dependence upon the selected continuous deceleration. This may reduce the risk of instabilities of the vehicle train but the risk still remains to a significant extent. There is therefore a need for methods of controlling vehicle trains that provide improved safety.

### SUMMARY

It is an object of the disclosure to provide a method for controlling a vehicle train, a driver assistance system, a commercial vehicle and/or a computer program product, which offers increased safety.

In a first aspect, the object is achieved by a method for controlling a vehicle train, having a towing vehicle and at least one trailer vehicle, wherein the towing vehicle comprises a continuous deceleration device which is provided to perform a continuous deceleration, the method comprising: determination of a trailer mass of the trailer vehicle in the prevailing vehicle configuration of the vehicle train; determination of a towing vehicle mass of the towing vehicle in the prevailing vehicle configuration; determination of a mass ratio of the prevailing vehicle configuration based on the trailer mass and the towing vehicle mass; and limitation of a permissible continuous deceleration power of the continuous deceleration device based on the mass ratio.

The continuous deceleration device is provided so as to provide a lengthy continuous deceleration at least of a vehicle part of the vehicle train. The lengthy continuous deceleration or the continuous deceleration is preferably wear-free or subject to low wear. The continuous deceleration device is preferably a continuous braking device of the vehicle train which can also be referred to as a retarder. Alternatively or additionally, the continuous deceleration device can also be a recuperation device. A recuperation device is configured so as to provide deceleration and in so doing covert kinetic energy into electric energy. The disclosure is based on the knowledge that a risk of a vehicle train or of individual vehicle parts of a vehicle train becoming unstable is significantly influenced by a prevailing vehicle configuration of the vehicle train. The prevailing vehicle configuration affects both vehicle-specific aspects and also load-specific aspects. In addition to geometric characteristics of the vehicle train, such as for example wheelbases, track widths, axle spacings and towing bar lengths, loading characteristics of the vehicle train also affect its stability behavior. Thus, in particular a mass ratio of the prevailing vehicle configuration has a large influence on the stability behavior of the vehicle train. By way of example, a first vehicle train whose trailer vehicle is heavily laden while its towing vehicle is empty tends in general to become unstable much earlier than a geometrically identical second vehicle train, whose towing vehicle is laden and whose trailer vehicle is empty. The mass ratio therefore significantly influences the stability behavior of the vehicle train. This knowledge is used by the disclosure in order to propose a method for controlling a vehicle train, which preventively inhibits instability and/or reduces a risk of instability occurring. The permissible continuous deceleration power of the continuous deceleration device in the method in accordance with the disclosure is thus limited at least based on the mass ratio. The limitation of the continuous deceleration power renders it is possible to prevent the continuous braking device decelerating the vehicle train to such an extent that an instability of the vehicle train occurs. It is thus possible, for example, to prevent the towing vehicle from jack-knifing, wherein the towing vehicle is braked so sharply that a heavily laden trailer vehicle pushes toward the towing vehicle and a jack-knifing angle between the towing vehicle and the trailer vehicle becomes very large.

Therefore, a limit for the continuous deceleration power that can be provided by the continuous deceleration device is set based on the mass ratio. The limit is a maximum permissible continuous deceleration power which can be provided by the continuous deceleration device. By way of example, the continuous deceleration power can be limited to a limit of 600 kW, although the continuous deceleration device is technically configured so as to provide higher continuous deceleration powers, by way of example 700 kW. It is preferred that the limitation of a permissible continuous deceleration power can also be performed indirectly as a result of the limitation of a permissible deceleration torque. The limitation can be specifying an absolute limit and/or a relative limit. In the case of the relative limit, the defined limit is a relative portion, in particular a percentage value, of a technically maximum continuous deceleration power that can be provided by the continuous deceleration device. If, for example, a continuous deceleration device is technically configured so as to provide a maximum continuous deceleration power of 700 KW, the permissible continuous deceleration power can have a relative value of 50% of this technically maximum continuous deceleration power. In this case, the permissible continuous deceleration power is limited to 350 kW.

In the context of the present disclosure, limitation is to be understood to mean that the limit can also correspond to a technically maximum braking power that can be provided by the continuous deceleration device. The limitation does not automatically correspond to a restriction of the continuous deceleration power. It can also be provided that in the case of the limitation a continuous deceleration power is defined which corresponds to or is even greater than the technically maximum continuous deceleration power that can be provided by the continuous deceleration device. This can be the case, for example, if the mass ratio of the vehicle train is entirely non-critical. In this case, a limit can be set, but this limit has no influence on the actual driving behavior of the vehicle train since the limit of the continuous deceleration power corresponds to the technically maximum possible continuous deceleration power.

In the context of the present disclosure, the mass ratio is preferably a quotient, wherein the trailer mass forms the dividend and a total vehicle mass, which is a sum of the trailer mass and the towing vehicle mass, forms the divisor (trailer mass/total vehicle mass=trailer mass/(towing vehicle mass+trailer mass)=mass ratio). However, it is to be understood that the mass ratio can also be defined differently without deviating from the inventive concept. By way of example, the trailer mass can be the dividend and the towing vehicle mass can be the divisor (trailer mass/towing vehicle mass=mass ratio).

The trailer mass, total train mass and/or towing vehicle mass can also be determined as an approximation. For example, an approximation with an error of 10% may be sufficient. This can be particularly advantageous if one or more of the masses can only be estimated due to a lack of measurement values.

In a first embodiment of the method, the maximum permissible continuous deceleration power reduces with an increasing relative proportion of the trailer mass of a total mass of the vehicle train. The heavier the trailer or rather the greater the trailer mass, the greater a risk of instability of the vehicle in general in the case of an identical vehicle mass. In particular, the risk of the vehicle train jack-knifing is increased in the case of a comparatively heavy trailer vehicle. The relative proportion of the trailer mass increases if the trailer mass increases to a greater extent than the towing vehicle mass. The risk of jack-knifing increases with an increasing relative proportion of the trailer mass of the total mass of the vehicle, wherein the total mass for a vehicle train having a towing vehicle and a trailer vehicle is the sum of the trailer mass and towing vehicle mass. The maximum permissible continuous deceleration power is reduced with an increasing relative proportion of the trailer mass, so that the higher the relative proportion of the trailer mass, the lower the permissible continuous deceleration power that can be provided by the continuous deceleration device. In the case of the same towing vehicle mass, a maximum permissible continuous deceleration power of 300 kW can be limited in the case of a heavy trailer, for example, while a maximum permissible continuous deceleration power of 700 kW is possible in the case of an unladen trailer. According to the above definition, the mass ratio decreases with an increasing relative proportion of the trailer mass.

The permissible continuous braking power can preferably have a lower threshold which cannot be undercut. By way of example, the lower threshold can be 5% of a technically maximum continuous braking power of the continuous deceleration device. When the technically maximum continuous braking power has a value of 1000 kW, the lower threshold can be accordingly set to 50 kW. Below this threshold, the maximum permissible continuous deceleration power is preferably not further reduced even with an increasing relative proportion of the trailer mass.

In various embodiments, it is preferred that the method also includes: determination of a coupling length for a coupling force which acts during an operation of the vehicle train between the towing vehicle and the trailer vehicle; and limitation of the maximum permissible continuous deceleration power of the continuous deceleration device additionally based on the coupling length. It is preferred that the maximum permissible continuous deceleration power is increasingly limited with an increasing coupling length. The maximum permissible continuous deceleration power is therefore preferably indirectly proportional to the coupling length. The coupling force is a force that acts during the operation of the vehicle train between the towing vehicle and the trailer vehicle. By way of example, the towing vehicle transmits a towing force to the trailer vehicle as the commercial vehicle accelerates. On the other hand, if the towing vehicle is decelerated to a greater extent than the trailer vehicle, the trailer vehicle possibly transmits a thrust force as a coupling force to the towing vehicle. In particular in this case, an effect on the vehicle train overall and the towing vehicle in particular is also dependent upon a level arm length of a lever arm of the coupling force. On the one hand, this lever arm depends on a jack-knifing angle formed between the trailer vehicle and the towing vehicle and, on the other hand, on the coupling length. The coupling length is preferably a spacing between a coupling point of the towing vehicle and the last axle of the towing vehicle in the travel direction of the vehicle. When the lever arm is large, an identical coupling force creates a greater reaction torque on the towing vehicle than when the lever arm is small. For an identical jack-knifing angle, the lever arm of the coupling force increases with an increasing coupling length. By virtue of the limitation of the maximum permissible continuous deceleration power based on the coupling length, the influence of the lever arm on a reaction torque between the towing vehicle and the trailer vehicle is also taken into account indirectly since the coupling length also determines the lever arm. The maximum permissible continuous deceleration power can be limited based on the coupling length and based on the mass ratio in the simplest case by adding the limitations. It is thus possible to limit the maximum permissible continuous deceleration power based on the mass ratio by 10% and based on the coupling length by 15% so that a total limitation of 25% is achieved. In this case, the maximum permissible continuous deceleration power has a relative value of 75%. However, it is also possible to provide that, in order to limit the maximum permissible continuous deceleration power, a different (possibly more formalized) correlation of the influence factors is selected.

In an embodiment, the determination of the coupling length includes: determination of a lift status of a lift axle of the towing vehicle; determination of a trailer type of the trailer vehicle, determination of a coupling point using the trailer type; determination of a rear-most axle of the towing vehicle in a travel direction, wherein the rear-most axle in the travel direction is preferably determined using the lift status of the lift axle; and the determination of the coupling length as a spacing between the rear-most axle in the travel direction and the coupling point of the towing vehicle, wherein the spacing is determined in a vehicle longitudinal direction. The coupling point is the site at which the trailer vehicle is coupled to the towing vehicle. Modern towing vehicles usually have two couplings in order either to be able to couple a central axle trailer or a towing bar trailer. It is possible by determining the trailer type (central axle trailer or towing bar trailer) to determine which coupling is used and thus also where the coupling point is. A position of the coupling point can therefore be determined using the trailer type. It is preferred that the trailer type is determined based on trailer signals which are provided on a vehicle network, preferably a vehicle bus system, particularly preferably an ISO 11992 bus system. The trailer vehicle transmits forces to the towing vehicle at the coupling point. The rear-most axle of the towing vehicle in the travel direction is the particular axle which, when the vehicle is travelling in a straight line, crosses a point lying on the movement path of the vehicle as the last of the axles of the towing vehicle. In lieu of the rear-most axle in the travel direction, a position of an axle group center of a rear axle group of the towing vehicle can also be determined and used during the determination of the coupling length. In order to be able to transport large loads, commercial vehicles frequently comprise multiple, closely-spaced axles (usually rear axles) between which the applied loads are distributed. The rear axle group refers to the rear axles of the towing vehicle as part of an axle unit, wherein two closely-spaced rear axles form a tandem axle and three rear axles form a triple axle. It is to be understood that a single rear axle can also form an axle group. The axle group center of such a rear axle group of the vehicle defines approximately a relevant contact point in terms of travel dynamics of the vehicle, wherein the axle group center in the longitudinal direction is the midpoint between the rear axles of the rear axle group. For example, in the case of two axles, the axle group center is the midpoint between the two axles in the vehicle longitudinal direction. Due to the high relevance of the axle group center for the driving dynamics of the towing vehicle and the vehicle train, a spacing between the axle group center and the coupling point acting as the point of application of force is particularly suitable as a relevant coupling length to be considered. However, it is to be understood that the coupling length can also be defined differently. Commercial vehicles often have a so-called lift axle that can be raised or lifted, wherein the lift axle in the raised state is not in contact with the road. The lift status indicates at least whether the lift axle is raised or lowered. Since the lift axles are often part of the rear axle group, raising or lowering the lift axle also changes the position of the axle group center. If the lift axle is a trailing axle, the lift axle after being lowered is generally a rear-most axle of the vehicle. Similarly, lowering the lift axle shifts the axle group center in the direction of the coupling point. It is therefore advantageous to take the lift status into account during the determination of the rear-most axle in the driving direction or the position of the axle group center. It is to be understood that when determining the position of the axle group center, only one position in the vehicle longitudinal direction can be determined and/or that the position can be only determined relatively with regard to the vehicle.

In various embodiments, it is preferred that the method also includes: determination of a bend curvature of a road to be travelled on by the vehicle train; and limitation of the permissible continuous deceleration power of the continuous deceleration device additionally based on the determined bend curvature. The bend curvature corresponds to the reciprocal value of the bend radius of a bend performed by the road. A large bend curvature corresponds to a small bend radius. A risk of instabilities increases particularly in the case of sharp bend curvatures (tight bends with small bend radii). The limitation of the continuous deceleration power additionally based on the determined bend curvature renders it possible to further increase safety. It is thus possible, for example, to provide an additional limitation of the maximum permissible continuous deceleration power of 10% if the bend curvature of the road to be travelled on is less than a predefined minimum radius. The limitation based on the bend curvature can be added to limitations based on other influencing factors. However, it is also possible to provide that multiple influencing factors are jointly taken into account during the limitation of the maximum permissible continuous deceleration power of the continuous deceleration device. By way of example, the determined bend curvature, the mass ratio and/or the coupling length can also be weighted. It is preferred that the determination of a bend curvature includes the determination of a trajectory of the vehicle train and the determination of the bend curvature using the trajectory. The trajectory is preferably determined by an autonomous unit which can also be referred to as a virtual driver.

In accordance with an embodiment, the method also comprises: determination of a jack-knifing angle between the towing vehicle and the trailer vehicle; and limitation of the maximum permissible continuous deceleration power of the continuous deceleration device if the jack-knifing angle exceeds a jack-knifing angle limit value. The jack-knifing angle is an angle (actual jack-knifing angle) formed between the towing vehicle and the trailer vehicle. The jack-knifing angle has a value of 0° when driving in a steady straight line. The risk of instabilities of the vehicle train increases as the jack-knifing angle between the towing vehicle and the trailer vehicle increases. A dynamically effective lever arm of the vehicle is thus dependent upon the coupling length and the jack-knifing angle between the towing vehicle and the trailer vehicle. The limitation of the maximum permissible continuous deceleration power in the case of large jack-knifing angles renders it possible to prevent the vehicle train from jack-knifing. Generally, however, only jack-knifing angles which exceed a minimum value are relevant, so that a limitation is preferably only performed if the jack-knifing angle exceeds the jack-knifing angle limit value. However, it is to be understood that the jack-knifing angle limit value can also have a value of 0°. It is preferred that the maximum permissible continuous deceleration power is limited additionally based on the jack-knifing angle, wherein the limitation can be performed in an additive manner analogous to the above described influencing factors (bend curvature and coupling length) or by simultaneously taking into account multiple influencing factors. However, it is also possible to provide that a fixed limitation of the maximum permissible continuous deceleration power is performed if the jack-knifing angle limit value is exceeded. It is preferred that the maximum permissible continuous deceleration power is limited proportional to the jack-knifing angle. A large jack-knifing angle thus causes a severe limitation. A jack-knifing angle of 0° corresponds preferably to an unlimited maximum permissible continuous deceleration power. The maximum permissible continuous deceleration power is preferably limited to 0% of the technically possible continuous deceleration power if the jack-knifing angle is greater than or equal to 45°. The jack-knifing angle limit value preferably has a value which is selected from a range of 0° to 20°, preferably greater than 0° to 20°, preferably greater than 0° to 10°, particularly preferably greater than 0° to 5°, wherein the boundary values of the specified ranges are also preferred. The proportional limitation is preferably performed using a limitation with a limitation rate which particularly preferably includes a reduction of 2.5% depending upon the extent of the increase of the jack-knifing angle.

In an embodiment, the method also comprises: determination of a set jack-knifing angle between the towing vehicle and the trailer vehicle; and defining the jack-knifing angle limit value as a dynamic jack-knifing angle limit value which corresponds to the set jack-knifing angle plus a buffer angle. The jack-knifing angle limit value is not a fixed limit value but rather a jack-knifing angle limit value that changes in dependence upon the set jack-knifing angle. The dynamic jack-knifing angle limit value is advantageous since during the regular driving operation, by way of example when maneuvering the vehicle train, even large jack-knifing angles can occur without risking instability. By using the dynamic jack-knifing angle limit value, a limitation is only performed if the real jack-knifing angle is greater than the set jack-knifing angle. The buffer angle compensates for any measurement inaccuracies of the jack-knifing angle and/or errors during the determination of the set jack-knifing angle. However, the buffer angle can also have a value of 0°. The set jack-knifing angle can be estimated preferably based on two or more geometric characteristics of the vehicle train and a bend curvature of a road to be travelled on. It is preferred that the set jack-knifing angle can be determined based on predicted dynamic characteristics of the vehicle train and the curvature of the road to be travelled on. For a bend, the curvature is the inverse of the bend radius. It is also possible to provide that the set jack-knifing angle is determined from one or multiple geometric characteristics of an actual yaw rate and an actual vehicle speed. The set jack-knifing angle can also be determined using a trajectory which is preferably provided by an autonomous unit.

In an embodiment, the method also comprises: determination of a prevailing coefficient of friction for the vehicle train; limitation of the maximum permissible continuous deceleration power of the continuous deceleration device additionally based on the prevailing coefficient of friction. If the coefficient of friction is low, the adhesion between the vehicle train and a road being driven on is reduced. This is the case, for example, when the road is slippery. A risk of an instability of the vehicle train frequently increases if the coefficient of friction is low, so that the limitation of the maximum permissible continuous deceleration power of the continuous deceleration device additionally based on the prevailing coefficient of friction renders it possible to further increase the safety. It is thus possible, if the coefficient of friction is low, to limit the maximum permissible continuous deceleration power to a greater extent than in the case of an average coefficient of friction. The additional limitation is preferably performed by adding a limitation based on the coefficient of friction to a limitation based on other influencing factors (mass ratio, bend curvature, coupling length, jack-knifing angle). However, there can also be a complex correlation between the various factors influencing the limitation.

It is to be understood that errors can occur during the determination of the prevailing coefficient of friction. The determination of the prevailing coefficient of friction therefore also includes an approximation of the prevailing coefficient of friction. Furthermore, the prevailing coefficient of friction can only be qualitatively determined and/or categorized. Preferably, or alternatively, the determination of the prevailing coefficient of friction includes a determination of whether the prevailing coefficient of friction is less than and/or exceeds a predefined standard coefficient of friction. The determination of the coefficient of friction preferably includes a determination of a comparison rotational speed of a comparison wheel, a determination of a test rotational speed of a test wheel, and a determination of a wheel slip of the test wheel based on the determined test rotational speed and the determined comparison rotational speed, wherein the determination of the comparison rotational speed and the determination of the test rotational speed are performed simultaneously for at least a time interval. The comparison wheel is preferably a wheel of the towing vehicle that is free-rolling in the time interval and the test wheel is preferably a wheel of the towing vehicle which is braked in the time interval using the continuous deceleration device and/or a service brake of the towing vehicle. The test wheel and the comparison wheel are preferably assigned to different axles of the towing vehicle. It is particularly preferred that the test wheel is a wheel of a rear axle of the towing vehicle and the comparison wheel is a wheel of a front axle of the towing vehicle. Furthermore, the method comprises a detection of a test manipulated variable provided in the time interval for acting on the test wheel. The test manipulated variable is preferably a control variable of a brake actuator, particularly preferably of the continuous deceleration device. For example, the test manipulated variable can be a brake pressure or an electrical characteristic variable of an electrodynamic continuous deceleration device. The determination of the prevailing coefficient of friction preferably includes a determination of a brake slip of the test wheel using the test rotational speed and the comparison rotational speed.

In a variant, a brake slip of the test wheel, which is determined from a comparison of the test rotational speed of the test wheel and the comparison rotational speed of the comparison wheel, and the test manipulated variable provided for providing the brake slip at this test wheel render it possible to at least approximately determine the prevailing coefficient of friction between the wheels of the vehicle and a road being driven on. If, for example, the test wheel in the case of a snow-covered road and in the case of a dry, clean road is braked by providing the same test manipulated variable, in the case of the snow-covered road a greater brake slip is set at the test wheel than in the case of the dry, clean road. Using the brake slip and the controlled test manipulated variable, the prevailing coefficient of friction can be determined at least qualitatively in this manner. In particular, the determination of the prevailing coefficient of friction can moreover include a comparison with at least one reference value and/or a reference characteristic curve. By way of example, a value of the prevailing coefficient of friction for the determined combination of the brake slip and the test manipulated variable can be read from a pre-stored reference characteristic curve. Such a reference characteristic curve can be determined, by way of example, by test drives which can also be performed within the context of vehicle development, and pre-stored in advance in a control unit of the vehicle. Moreover, other characteristics can also be taken into account, such as for example, a total weight of the vehicle and/or a loading distribution on the vehicle train during the determination of the prevailing coefficient of friction. By way of example, the prevailing coefficient of friction for a specific combination can be determined from the brake slip, the test manipulated variable and the total weight of the towing train from an associated pre-stored characteristic curve.

In various embodiments, it is preferred that the method also comprises: determination of a downhill gradient of a road being travelled on by the vehicle train; and limitation of the permissible continuous deceleration power of the continuous deceleration device additionally based on the determined downhill gradient. The risk of the vehicle jack-knifing is increased in the case of a steep downhill gradient since in this case a downhill force acts on the towing vehicle and the trailer vehicle. This downhill force can lead to instabilities particularly in the case of asymmetric deceleration of the vehicle train because, for example, the trailer vehicle pushes towards a towing vehicle that is decelerated to a greater extent by the continuous deceleration device. When the maximum permissible continuous deceleration power is determined additionally based on the downhill gradient, this circumstance can be taken into account and safety is increased. It is preferred that the limitation is more pronounced the greater the downhill gradient. The additional limitation is preferably performed by adding a limitation based on the downhill gradient to a limitation based on other influencing factors (mass ratio, bend curvature, coupling length, jack-knifing angle, coefficient of friction). However, there can also be a complex correlation between the various factors influencing the limitation or its value. The downhill gradient is preferably determined using a trajectory of the vehicle train, using route information and/or using an inclination sensor of the vehicle train.

In accordance with a preferred embodiment, the method also comprises: provision of a compensation deceleration power at one of multiple axles of the vehicle train, which are independent of the continuous deceleration device, in order to at least partially compensate for an incorrect deceleration power caused by the limitation of the permissible continuous deceleration power of the continuous deceleration device. In order to decelerate the vehicle to a desired speed or to stop the vehicle in the case of a specific speed, it is necessary to provide a defined deceleration power dependent upon the kinetic energy and the forces acting on the vehicle. It is thus necessary to provide a deceleration power of approx. 400 kW, for example, in order to keep a vehicle train having a total mass of 40 ton on a downhill gradient of 10% to a constant speed of 36 km/h. However, if the maximum permissible continuous deceleration power is limited to a value of 300 kW, there is a deceleration power error of 100 kW. If the vehicle is to be kept at a constant speed when driving on the downhill gradient, it is necessary to provide a compensating deceleration power. The compensation deceleration power is preferably provided by one or multiple service brakes of the vehicle train. Thus, a required deceleration can also be achieved if the maximum permissible continuous deceleration power is insufficient in order to ensure this. An axle is independent of the continuous deceleration device if its wheels are not braked or cannot be braked by the continuous deceleration device. If, for example, a continuous deceleration device is only provided on one rear axle of a commercial vehicle, then one front axle of the commercial vehicle is independent of the continuous deceleration device. The axle independent of the continuous deceleration device can, alternatively or additionally, also be an axle of a trailer vehicle if the continuous deceleration device acts on an axle of a towing vehicle. It is preferred that the compensation deceleration power is provided on one of the axles independent of the continuous deceleration device since braking or deceleration at the axle of the continuous deceleration device would counteract the effect of the limitation. It is preferred that the compensation deceleration power is provided at least partially at the trailer vehicle. It is thus possible to effectively prevent the vehicle train from jack-knifing.

The method preferably also comprises: performance of a trailer braking maneuver of the vehicle train using a trailer deceleration device of the trailer vehicle if a continuous deceleration power required for the vehicle train is greater than the maximum permissible continuous deceleration power. Performance of a trailer braking maneuver means braking the vehicle train in which the trailer vehicle is decelerated to a greater extent than the towing vehicle. Performance of a trailer braking maneuver counteracts the vehicle train jack-knifing and can stabilize the vehicle train. It is preferred that the trailer deceleration device comprises service brakes of the trailer vehicle. The trailer deceleration device is configured so as to cause the trailer vehicle to decelerate. The trailer braking maneuver is performed if the maximum permissible continuous deceleration power is less than the required deceleration power, in other words, if, due to the limitation, the continuous braking device is no longer sufficient to provide the required deceleration power. In this case, further braking of the towing vehicle could cause the vehicle train to jack-knife, which can be prevented by the performance of the trailer braking maneuver. The required continuous deceleration power is a continuous deceleration power requested by a human driver and/or a control unit.

It is preferred that the method also comprises: emitting a warning signal if the maximum permissible continuous deceleration power is less than a technically possible continuous deceleration power of the continuous deceleration device. The warning signal is therefore emitted in the case of an actual limitation of the continuous deceleration power. A driver of the vehicle can thus be informed that it may be necessary to also use other deceleration devices, such as in particular service brakes of the vehicle train. If, following on from the example described above, the continuous deceleration device is technically capable of providing a continuous deceleration power of 700 kW, but the maximum permissible continuous deceleration power is limited to a lower value of only 400 kW, then the warning signal is emitted in accordance with the preferred development of the method.

In a second aspect, the disclosure achieves the object mentioned in the introduction with a driver assistance system for a commercial vehicle, the driver assistance system being configured so as to perform the method in accordance with the first aspect of the disclosure. The commercial vehicle is preferably a vehicle train. It is to be understood that the driver assistance system can be entirely arranged in a towing vehicle, wherein the driver assistance system can only perform the method in accordance with the first aspect of the disclosure if a trailer vehicle is attached to the towing vehicle.

In a third aspect, the disclosure achieves the object mentioned in the introduction by means of a driver assistance system for a vehicle train with a towing vehicle and at least one trailer vehicle, wherein the vehicle train has a continuous deceleration device, the driver assistance system comprising a control unit which can be connected to at least one network of the vehicle train so as to receive signals, and an interface to a continuous deceleration device of the towing vehicle, wherein the control unit is configured so as to receive signals and based on the signals to determine a trailer mass of the trailer vehicle in the prevailing vehicle configuration of the vehicle train and a towing vehicle mass of the towing vehicle in the prevailing vehicle configuration, wherein the control unit is also configured so as based on the trailer mass and the towing vehicle mass to determine a mass ratio of the prevailing vehicle configuration, to limit a permissible continuous deceleration power of the continuous deceleration device in dependence upon the mass ratio, and to provide at the interface a signal that represents the limited permissible continuous deceleration power (or one representing the maximum permissible continuous deceleration power).

In a fourth aspect, the object mentioned in the introduction is achieved with a commercial vehicle, comprising a continuous deceleration device and a driver assistance system in accordance with the second aspect of the disclosure and/or a driver assistance system in accordance with the third aspect of the disclosure. The commercial vehicle is preferably a vehicle train. However, it can also be provided that the commercial vehicle is a towing vehicle. It is particularly preferred that the driver assistance is then configured so as to only perform the method in accordance with the first aspect of the disclosure if a trailer vehicle is attached to the commercial vehicle.

In accordance with a fifth aspect, the disclosure achieves the object mentioned in the introduction with a computer program product having program code which is stored on a computer-readable data carrier in order to perform the method according to the first aspect of the disclosure if the program product is executed on a computing unit of a commercial vehicle that has a lift axle. The commercial vehicle is preferably a commercial vehicle in accordance with the fourth aspect of the disclosure.

It is to be understood that the driver assistance system in accordance with the second and/or third aspect of the disclosure, the commercial vehicle in accordance with the fourth aspect of the disclosure and the computer program product in accordance with the fifth aspect of the disclosure can have identical and similar sub-aspects to the method in accordance with the first aspect of the disclosure.

### BRIEF DESCRIPTION OF DRAWINGS

The invention will now be described with reference to the drawings wherein:

FIG. 1 shows a schematic representation of a vehicle train in a plan view;

FIG. 2 shows the vehicle train in accordance with FIG. 1 in a lateral view; and,

FIG. 3 shows a method for controlling the vehicle train.

### DETAILED DESCRIPTION

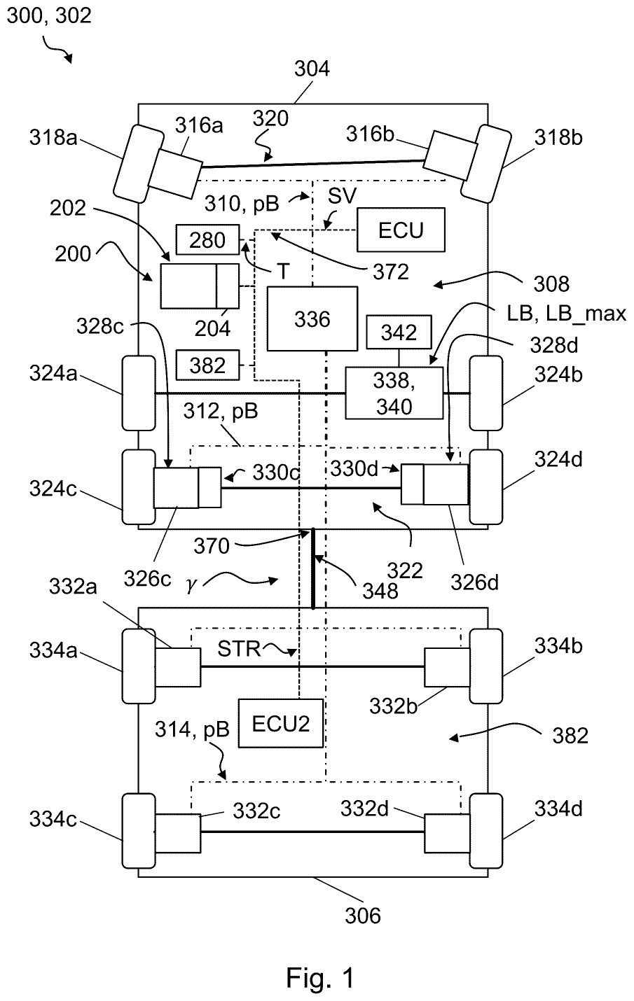

FIG. 1 illustrates a vehicle 300 which in this case is a vehicle train 302 with a towing vehicle 304 and a trailer vehicle 306. The vehicle 300 comprises a brake system 308 with a front axle brake circuit 310, a rear axle brake circuit 312 and a trailer brake circuit 314. The front axle brake circuit 310 comprises two front axle brake actuators 316a, 316b which are assigned to front wheels 318a, 318b of a front axle 320 of the towing vehicle 304. Rear axle brake actuators 326c, 326d are arranged on rear wheels 324a, 324b, 324c, 324d of a rear axle group 322 of the vehicle 304 and are assigned to the rear axle brake circuit 312 and are configured for controlling a brake slip at the rear wheels 324. For reasons of presentation, only rear axle brake actuators 324c, 326d are shown here on two of the rear wheels 324c, 324d. It is to be understood that the rear axle brake circuit 312 can have a rear axle brake actuator 326 for each of the rear wheels 324. The rear axle brake actuators 326 are multi-action brake actuators which, in addition to a service brake part 328c, 328d, also have a spring storage part 330c, 330d that serves as a parking brake. A spring arranged in the respective spring storage part 330c, 330d tensions the rear axle brake actuator 326 if no pneumatic release pressure is provided in the spring storage part 330c, 330d. In order to be able to move the vehicle 300 or to release the parking brake, the release pressure is provided, wherein the spring is tensioned and the respective rear axle brake actuator 326 is released.

In order to brake the trailer vehicle 306, the trailer brake circuit 314 has trailer brake actuators 332a, 332b, 332c, 332d which are assigned to trailer wheels 334a, 334b, 334c, 334d of the trailer vehicle 306. The front axle brake actuators 316, rear axle brake actuators 326 and trailer brake actuators 332 are pneumatic brake actuators 316, 326, 332 which, simplified in the present embodiment, are supplied with brake pressure pB by a common brake modulator 336. However, it is to be understood that each brake circuit 310, 312 or 314 can have one or multiple dedicated brake modulators and/or that the brake actuators 316, 326, 332 of a brake circuit 310, 312, 314 or different brake circuits 310, 312, 314 can also be supplied with brake pressures pB which are different from one another. It is thus possible, by way of example, for a brake pressure pB at the front axle brake actuator 316a of the left-hand front wheel 318a to be different from a brake pressure pB at the front axle brake actuator 316b of the right-hand front wheel 318b.

The front axle brake actuators 316, rear axle brake actuators 326 and the trailer brake actuators 332 are service brakes of the vehicle 300 which are configured in this case as friction brakes and which convert kinetic energy of the vehicle 300 into thermal energy by means of friction between brake discs (not shown in the figures) and corresponding brake linings (also not shown in the figures) in order to decelerate the vehicle 300. If the vehicle 300 is decelerated exclusively by means of the brake actuators 316, 326, 332, then the friction effect leads to a high wear, which in turn causes high operating costs for the vehicle. Furthermore, the front axle brake actuators 316, rear axle brake actuators 326 and/or the trailer brake actuators 332 can reach very high temperatures when driving on a long and/or steep downhill slope, which may limit their braking function under certain circumstances. For this reason, the vehicle 300 also has a continuous deceleration device 338 which in the illustrated embodiment is a hydrodynamic retarder 340. The retarder 340 is arranged on the rear axle group 322 and is configured so as to decelerate the rear wheels 324c, 324d of the towing vehicle 304 or control a brake slip at the rear wheels. Due to its hydrodynamic operating principle, the continuous deceleration device 338 is configured to provide a continuous deceleration power LB for the vehicle 300 with almost no wear. The continuous deceleration power LB can be used, for example, to continuously brake the vehicle 300 when driving on a long downhill slope in order to thus keep the vehicle 300 in a non-critical speed range and to protect the service brakes. An actuating lever 342 is provided to activate and deactivate the continuous deceleration device 338, which can be actuated by a driver of the vehicle 300. The continuous deceleration device 338 can be metered by means of this actuating lever 342. However, it is also possible to provide that the continuous deceleration device 338 is purely electronically activated, deactivated and/or metered by way of example by a main control unit ECU of the towing vehicle 304.

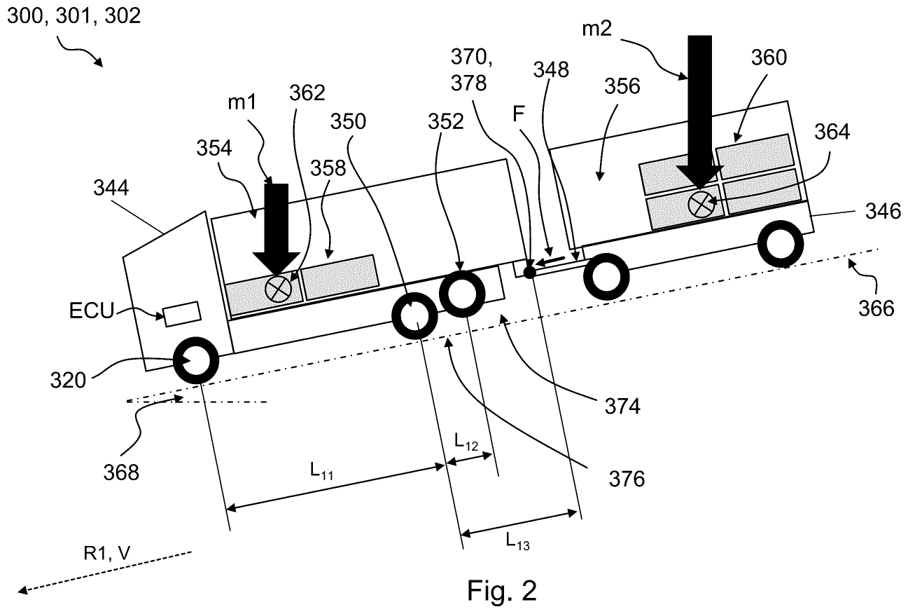

FIG. 2 shows the vehicle train 302 in a lateral view, wherein the towing vehicle 304 is a lorry 344. The trailer vehicle 306 is a towing bar trailer 346 which is connected to the towing vehicle 304 via a towing bar 348. It is also apparent in the lateral view in accordance with FIG. 2, that, in addition to a rear axle 350, the rear axle group 322 has an additional axle 352 which can be lifted or raised or a lift axle 352 which is raised. It is possible by lowering the lift axle 352 to distribute a loading of the trailer vehicle 304 onto an additional axle so that the axle loading reduces for each axle 320, 350, 352. The lift axle 352 is a trailing axle in this case. An effective wheelbase with regard to the driving dynamics of the towing vehicle 304 changes as the lift axle 352 is lowered. In the case of a raised lift axle 352, the effective wheelbase with regard to the driving dynamics of the towing vehicle 304 corresponds to an axle spacing L11 between the front axle 320 and the rear axle 350 which is measured in a vehicle longitudinal direction R1. In the case of a lowered lift axle 352, half a lift axle spacing L12 is added to this axle spacing L11 so that the effective wheelbase for driving dynamics of the towing vehicle 304 when the lift axle 352 is lowered corresponds in this case to the sum L11+L12/2. The lift axle spacing describes the spacing between the rear axle 350 and the lift axle 352 determined in the vehicle longitudinal direction R1.

The loading on the vehicle 300 results on the one hand from the intrinsic weight of the towing vehicle 304 and the trailer vehicle 306, and on the other hand from its load. The towing vehicle 304 has a first load area 354 on which a first load 358 is arranged. A second load 360 is arranged on a second load area 356 of the towing bar trailer 346. FIG. 2 illustrates by the number of the blocks representing the loads 358, 360 that the trailer vehicle 306 is loaded considerably more heavily than the towing vehicle 304. A towing vehicle mass m1 of the towing vehicle 304 which is essentially determined from an empty mass of the towing vehicle 304 and the mass of the first load 358 is illustrated as an arrow pointing at the center of gravity 362 of the towing vehicle 304. In a similar manner, a trailer vehicle mass m2 of the trailer vehicle 306 which is essentially determined from an empty mass of the trailer vehicle 306 and the mass of the second load 360 is illustrated as an arrow pointing at the center of gravity 364 of the trailer vehicle 306. The uneven distribution of the loading between the towing vehicle 304 and the trailer vehicle 306 is clarified by the length of the arrows illustrating the masses m1, m2.

In FIG. 2, the vehicle train 302 is travelling on a road 366 which has a downhill gradient 368. Due to the downhill gradient 368, a part of the weight force resulting from the masses m1, m2 acts in the vehicle longitudinal direction R1. This force component, also known as the downhill force, causes the vehicle 300 to accelerate in the vehicle longitudinal direction R1 if it is not counterbalanced by an opposing force. The continuous deceleration device 338 provides a (or where appropriate more) continuous deceleration power so as to continuously compensate for the downhill force.

The imbalance of the masses m1, m2 is unfavorable in terms of the driving stability of the vehicle 300. The trailer mass m2 is thus considerably greater than the towing vehicle mass m1, which in the case of an identical speed V of the towing vehicle 304 and of the trailer vehicle 306 causes the trailer vehicle 306 to have significantly more kinetic energy than the towing vehicle 304. In order to decelerate the trailer vehicle 306 over a specific period of time, it is therefore necessary in this period of time to also provide a significantly greater deceleration power at the trailer vehicle 306 than at the towing vehicle 304. If, in contrast, the same deceleration power is provided for both vehicle parts 304, 306, the trailer vehicle 306 is braked less intensely and pushes towards the towing vehicle 304. In this case, the trailer vehicle 306 transmits by means of the towing bar 348 a coupling force F to a coupling 370 of the towing vehicle 304. This coupling force F can destabilize the towing vehicle 304 and under certain circumstances can lead to critical driving conditions. Since the continuous deceleration device 338 in the present embodiment only acts on the rear axle 350 of the rear axle group 322 of the towing vehicle 304, the risk of instabilities of the vehicle 300 greatly increases in the case of an unfavorable loading distribution, particularly if the vehicle 300 is braked solely by means of the continuous deceleration device 338. This means that the vehicle 300 can become unstable when travelling on the road 366 with the downhill gradient 368 if the continuous deceleration device 338 in the case of an unfavorable loading distribution or unfavorable ratio between the towing vehicle mass m1 and the trailer mass m2 provides an excessive continuous deceleration power LB.

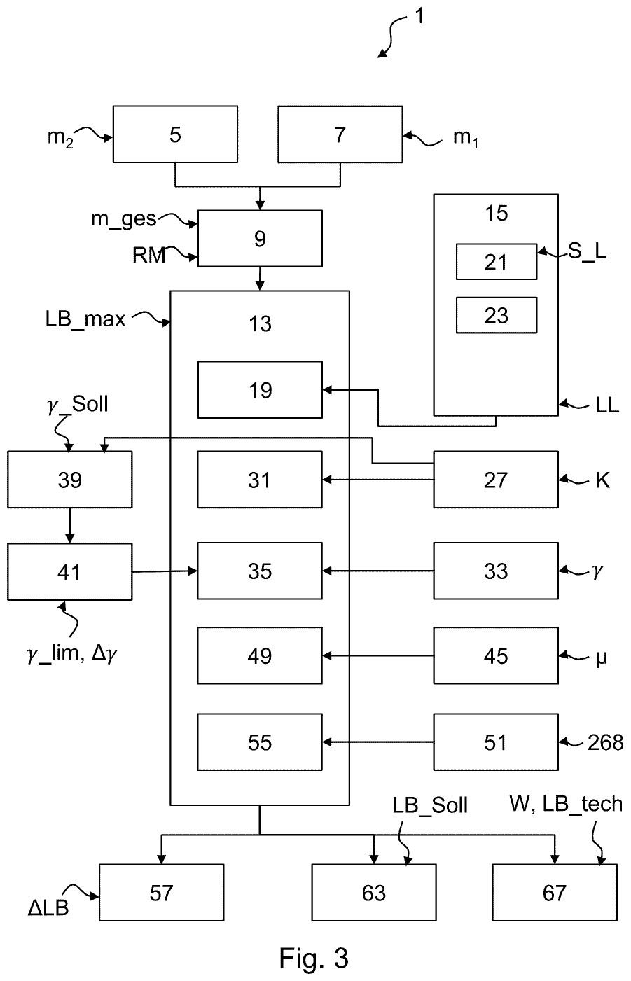

In order to prevent such instability of the vehicle 300, the vehicle 300 has a driver assistance system 200. The driver assistance system 200 comprises a control unit 202 and an interface 204. The interface 204 is connected to a vehicle network 372, which in this case is an ISO 11992 CAN vehicle bus, to other assemblies and/or units of the towing vehicle 304 and of the trailer vehicle 306. Thus, the control unit 202 of the driver assistance system 200 in the present embodiment is connected via the vehicle network 372 to the continuous deceleration device 338 for control purposes. Moreover, the control unit 202 is connected via the vehicle network 372 to the main control unit ECU of the towing vehicle and to a trailer control unit ECU2 of the trailer vehicle 306. The vehicle assistance system 200 is configured so as to perform a method 1 for controlling the vehicle train 302, and the method is explained below with regard to FIG. 3. In the present embodiment, a risk of instabilities of the vehicle 300 can be reduced by means of the method 1.

A determination 5 of the trailer mass m2 is performed in a first step of the method 1. In the illustrated embodiment, the control unit 202 of the driver assistance system 200 receives for this purpose trailer signals STR which are provided by the trailer control unit ECU2 on the vehicle network 372. The control unit 202 then uses the trailer signals STR to determine the trailer mass m2. In this case, the control unit 202 evaluates axle loading signals included in the trailer signals STR and mathematically determines the trailer mass m2 therefrom. However, it can also be provided in other embodiments that the trailer control unit ECU2 or the main control unit ECU of the towing vehicle 304 provides signals on the vehicle network 372 which directly represent the trailer mass m2.

A determination 7 of the towing vehicle mass m1 is performed in a second step of the method 1 which is performed in this case parallel to the determination 5 of the trailer mass m2. The towing vehicle mass m1 is also determined 7 in the illustrated embodiment by the control unit 202 of the driver assistance system 200. For this purpose, the control unit 202 receives vehicle signals SV which are provided on the vehicle network 372. The vehicle signals SV include in this case a vehicle type, from which the control unit 202 determines an empty mass of the towing vehicle 304. Moreover, the vehicle signals SV comprise geometric characteristics of the towing vehicle 304, such as the axle spacing L11, the lift axle spacing L12 and a lift status S_L. The lift status S_L can represent at least one raised lift axle 352 and a lowered lift axle 352 so that, using the lift status S_L, the control unit 202 can determine whether the lift axle 352 is raised or lowered. Moreover, the vehicle signals SV include in this case an axle loading on the rear axle 350 of the towing vehicle 304 and an axle loading on the front axle 320 of the towing vehicle 304. The control unit 202 uses the axle loadings on the front axle 320 and the rear axle 350 to determine the towing vehicle mass m1, (the lift axle 352 is raised in the embodiment in accordance with FIG. 2 and is not carrying a load). However, it can also be provided that the determination 7 of the towing vehicle mass m1 is performed based on vehicle signals SV which represent the towing vehicle mass m1 directly. It is thus possible, for example, for the main control unit ECU of the towing vehicle 304 to be configured so as to provide the vehicle signals SV representing the towing vehicle mass m1 on the vehicle network 372. However, it is to be understood that other units or assemblies of the vehicle 300 can also be configured so as to determine the towing vehicle mass m1 and preferably provide it on the vehicle network 372. It is thus possible for a brake control unit of the brake system 308 to determine the towing vehicle mass m2.

The towing vehicle mass m1 and the trailer mass m2 determine decisively a prevailing vehicle configuration 301 of the vehicle train 300. The prevailing vehicle configuration 301 comprises in addition to geometric characteristics of the vehicle 300 therefore also loading characteristics which concern aspects specific to the load. The geometric characteristics represent the geometry of the vehicle 300. It is preferred that, in addition to or in lieu of geometric dimensions, the geometric characteristics can also include information regarding quantity (for example a number of axles of the vehicle 300). Geometric characteristics are or comprise in particular geometric variables defining the driving dynamics of the vehicle 300, such as the axle spacing L11, the lift axle spacing L12, a track width of the vehicle, a coupling spacing L13 between the rear axle 350 of the towing vehicle 304 and the coupling 370 which is measured in the vehicle longitudinal direction R1, and/or a configuration shape or a type of trailer vehicle 306 (for example a towing bar trailer 346 or central axle trailer).

The loading characteristics represent loads which are acting on the vehicle 300 and which can result from the intrinsic weight of the vehicle 300 (incl. operating materials) and the load 358, 360 of the vehicle 300. Thus, a prevailing vehicle configuration of an unladen vehicle 300 is different from the prevailing vehicle configuration of the laden vehicle 300 illustrated in FIG. 2.

The determination 5 of the trailer mass m2 and the determination 7 of the towing vehicle mass m1 are performed simultaneously here, but in variants of the method 1 they can also be performed at different times or partially simultaneously. Thus, the determination 7 of the towing vehicle mass m1 can be performed prior to performing the determination 5 of the trailer mass m2. It is preferred that the determination 5 of the trailer mass m2 and the determination 7 of the towing vehicle mass m1 are performed during a vehicle activation of the vehicle 300, which can also be referred to as a start-up. The start-up is usually performed by activating the ignition of a vehicle 300 or by operating a drive switch. The determination 5 and/or the determination 7 which are performed during a vehicle activation are triggered by the vehicle activation but do not necessarily have to be performed at the same time and also not jointly with the vehicle activation.

In a step of the method 1 which follows the determination 5 of the trailer mass m2 and the determination 7 of the towing vehicle mass m1, these masses m1, m2 are used to determine a mass ratio RM of the prevailing vehicle configuration 301 (determination 9 in FIG. 3). The mass ratio RM sets the towing vehicle mass m1 and the trailer mass m2 in relation to one another, wherein the mass ratio RM in the present embodiment is the quotient of the trailer mass m2 and a total vehicle mass m_ges, which corresponds to the sum of the towing vehicle mass m1 and the trailer mass m2 (RM=m2/m_ges=m2/(m1+m2)). In the simplest case, however, the mass ratio RM can also be the quotient of the towing vehicle mass m1 and the trailer mass m2 (RM=m2/m1), a reciprocal value of the above definitions or defined entirely differently.

The coupling force F which is applied to the coupling 370 of the towing vehicle 304 by the non-braked trailer vehicle 306 within the context of continuous braking by the continuous deceleration device 338 of the towing vehicle 304 is dependent upon the continuous deceleration power LB of the continuous deceleration device 338 and directly proportional to the mass ratio RM. In other words, the greater the mass ratio RM, the greater also the coupling force F transmitted to the coupling 370 if only the continuous deceleration device 338 of the towing vehicle 304 initiates a deceleration of the vehicle 300. For a vehicle train which has a regular lorry 344 with a towing vehicle empty mass of 12 ton and a maximum towing vehicle mass of 25 ton and a regular towing bar trailer 346 with a trailer empty mass of 6 ton and a maximum trailer mass of 18 ton, a range of mass ratio RM of 0.2 to 0.6 is produced. Depending upon the load of the vehicle 300, the coupling force F is therefore subject to a wide range of fluctuation. A transmission ratio of the braking force provided by the continuous deceleration device 338 of the towing vehicle 304 into the coupling force F has a maximum spread of 300% in this example, depending upon the loading differences between the towing vehicle 304 and the trailer vehicle 306. However, it is to be understood that for other vehicles 300, other values of the mass ratio RM can also occur.

Since excessive coupling forces F increase a risk of instabilities of the vehicle 300, this risk can be reduced by the limitation of the coupling force F. For this purpose, a limitation 13 of a maximum permissible continuous deceleration power LB_max is performed in the method 1 following the determination 9 of the mass ratio RM. The continuous deceleration power LB is the continuous deceleration power provided by the continuous deceleration device 338 in the prevailing situation, while the maximum permissible continuous deceleration power LB_max is a limit value which the prevailing continuous deceleration power LB must not exceed. While the continuous damping device 338 is decelerating the vehicle 300, the continuous damping power LB provided during the deceleration can assume any value that is less than or equal to the maximum permissible continuous deceleration power LB_max. The continuous deceleration power LB is directly proportional to the braking force provided by the continuous deceleration device 338 within the context of a continuous deceleration, so that the lower the braking force provided, the lower the continuous deceleration power LB. By virtue of the limitation 13 of the maximum permissible continuous deceleration power LB_max, it is thus ensured that the braking force provided by the continuous deceleration device 338 does not exceed a maximum value. Due to the aforementioned correlation between the braking force and the coupling force F, the coupling force F produced during the continuous deceleration of the towing vehicle 304 by means of the continuous deceleration device 338 at the coupling 370 of the towing vehicle 304 is also limited by virtue of the limitation 13 of the maximum permissible continuous deceleration power LB_max. This limitation 13 of the maximum permissible continuous deceleration power 338 is adapted to the prevailing vehicle configuration 301, since it is based on the mass ratio RM. Thus, the maximum permissible continuous deceleration power LB_max can be limited to a greater extent in the case of a large mass ratio RM, for example, than for a small mass ratio RM. Instabilities can be prevented even when the vehicle 300 is heavily loaded at the rear.

The maximum permissible continuous deceleration power LB_max must not necessarily be smaller than a technically possible continuous deceleration power LB_tech. The technically possible continuous deceleration power LB_tech is a continuous deceleration power which the continuous deceleration device 338 can provide as a maximum due to its configuration and other technical factors. Thus, the maximum permissible continuous deceleration power LB_max in the case of a mass ratio RM of 0.2, which corresponds in the present embodiment to a fully-laden lorry 344 and an empty towing bar trailer 348, can also be equal to the technically possible continuous deceleration power LB_tech. In the case of a mass ratio RM of 0.6, which corresponds in the present embodiment to an empty lorry 344 and a fully-laden towing bar trailer 348, the maximum permissible continuous deceleration power LB_max can in contrast only be a fraction (for example 20%) of the technically possible continuous deceleration power LB_tech. In this case, the maximum permissible continuous deceleration power LB_max is reduced with an increasing relative proportion of the trailer mass m2 of the total mass m_ges of the vehicle train 302. In accordance with the definition of the mass ratio RM (RM=m2/(m1+m2) provided in this embodiment, the relative proportion of the trailer mass m2 increases if the mass ratio RM increases. Therefore, the greater the mass ratio RM, the greater the extent to which the maximum permissible continuous deceleration power LB_max is limited.

A lever arm 374 for the coupling force F on the vehicle 300 and which acts on the coupling 370 and is induced by the trailer vehicle 306 pushing forward, represents a further factor influencing possible instabilities of the vehicle 300. The lever arm 374 is essentially determined by a coupling length LL and a jack-knifing angle γ between the towing vehicle 204 and the trailer vehicle 306. It is thus possible in the case of a large lever arm 374 which increases with an increasing coupling length LL for the same coupling force F to apply a higher reaction torque on the towing vehicle 304 than in the case of a small lever arm 374. The limitation of the maximum permissible continuous deceleration power LB_max is therefore performed in the present embodiment additionally based on the coupling length LL (limitation 19 in FIG. 3). However, it is to be understood that the limitation 13 of the maximum permissible continuous deceleration power LB_max can also be performed without using the coupling length LL.

In order to be able to take into account the coupling length LL during limitation 19, the method 1 includes a determination 15 of the coupling length LL which is performed prior to performing the limitation 13, 19. In this case, the coupling length LL is a spacing of the coupling 370 determined in a vehicle longitudinal direction R1 from a point of contact of the rearmost axle of the vehicle 300 in the direction of travel. In the case of a raised lift axle 352, the coupling length LL therefore corresponds to the coupling spacing L13 between the rear axle 350 and the coupling 370 (LL=L13) whereas the coupling length LL in the case of a lowered lift axle 352 is reduced to a value which corresponds to the coupling spacing L13 less the lift axle spacing L12 (LL=L13−L12).

In the present embodiment, the determination 15 of the coupling length LL initially includes a determination 21 of the lift status S_L which is performed in this case by the control unit 202 of the driver assistance system 200 based on the vehicle signals SV. Furthermore, the determination 15 of the coupling length LL includes a determination 23 of a position of an axle group center 376 in the vehicle longitudinal direction R1 (indicated in FIG. 2 for a lowered lift axle 352) using the lift status S_L. Subsequently in the method 1, the coupling length LL is determined as a spacing between the axle group center 376 and the coupling 370 or a coupling point 378 of the towing vehicle 304 defined by the coupling 370. In the present embodiment, the control unit 202 of the driver assistance system 200 also performs the determination 23.

Conventional lorries 344 also have, in addition to the coupling 370 which is provided for coupling towing bar trailers 346, a further coupling (not illustrated in the figures) which is provided for coupling other trailer types, such as in particular central axle trailers. A so-called deep-coupling for central axle trailers is usually arranged closer to the rear axle 350 or the rear axle group 322 so that the coupling length LL can change depending upon the trailer type. The determination of the coupling length LL therefore preferably includes a determination of a trailer type of the trailer vehicle 306. In the present case, the trailer type of the trailer vehicle 306 is included in the trailer signals STR so that the control unit 202 of the driver assistance system can determine the trailer type based on the trailer signals STR. Since the trailer signals STR in this case represent a towing bar trailer 346, the control unit 202 can determine a position of the coupling point 378 which in this case is the position of the coupling 370. The position of the coupling 370 can be determined, for example, using the vehicle signals SV which also include here corresponding geometric characteristics of the towing vehicle 304. The coupling length LL is thus known and can be used for performing the limitation 19 of the maximum permissible continuous deceleration power LB_max using the coupling length LL and the mass ratio RM.

In the present method 1, the maximum permissible continuous deceleration power LB_max is moreover limited based on a bend curvature K of the road 366 being driven on by the vehicle train 302 (limitation 31 in FIG. 3). A determination 27 of the bend curvature K is performed prior to performing this limitation 31. In this case, during the determination 27, the control unit 202 of the driver assistance system 200 determines the bend curvature K based on a trajectory T which is provided by an autonomous unit 380 of the vehicle. However, it is also possible to provide that the control unit 202 determines the bend curvature K based on route information which is provided by a vehicle navigation system or another unit of the vehicle 300 on the vehicle network 372. In general, a risk of instabilities of the vehicle 300 in the case of sharp bends in the road 366 or in the case of large bend curvatures K of the road 366 in comparison to gentle bends with small bend curvatures K increases since greater lateral guiding forces must be provided in order to guide the vehicle along the bend. The influence of the bend curvature K of the road 366 can therefore be advantageously taken into account in the method 1 in order to further reduce the risk of instabilities of the vehicle 300.

Large jack-knifing angles y between the towing vehicle 204 and the trailer vehicle 306 also increase the risk of instabilities of the vehicle train 302. Thus, in the case of high values of the jack-knifing angle γ, a risk of the vehicle train 302 jack-knifing is increased, in particular because the lever arm 374 for the coupling force F increases with an increasing jack-knifing angle γ. It is therefore advantageous to limit the maximum permissible continuous deceleration power LB_max also based on the jack-knifing angle γ, as occurs in the method in accordance with FIG. 3 by virtue of the limitation 35. Prior to performing the limitation 35, the jack-knifing angle γ is determined by the control unit 202 of the driver assistance system 200 (determination 33 in FIG. 3). In the case of the vehicle train 302 according to FIG. 1, the jack-knifing angle y has a value of 0° because the trailer vehicle 306 is driving straight behind the towing vehicle 204. Within the context of the vehicle train 302 negotiating a bend, the jack-knifing angle y increases and the risk of instabilities increases. In the illustrated embodiment of the method 1, it is therefore provided that the maximum permissible continuous deceleration power LB_max is limited if the jack-knifing angle γ exceeds a jack-knifing angle limit value γ_lim. In this case, the jack-knifing angle limit value γ_lim takes into account that specific values of the jack-knifing angle γ are harmless with respect to the stability of the vehicle train 302 and are also unavoidable within the context of negotiating a bend. Therefore, the limitation 35 is preferably only performed if the jack-knifing angle γ exceeds the jack-knifing angle limit value γ_lim. In the present example, the jack-knifing angle limit value γ_lim is a dynamic limit value that also takes into account the bend curvature K. Thus, the jack-knifing angle limit γ_lim has a higher value here in the case of large bend curvatures K than in the case of small bend curvatures K, since in the case of sharp bends in general larger jack-knifing angles γ also occur between the towing vehicle 304 and the trailer vehicle 306.

In order to define 41 the dynamic jack-knifing limit value γ_lim, the method 1 initially includes the determination 39 of a set jack-knifing γ_Soll between the towing vehicle 304 and the trailer vehicle 306. The set jack-knifing γ_Soll is determined using the bend curvature K. The fact that the bend curvature is taken into account during the determination 39 of the set jack-knifing angle γ_Soll is illustrated in FIG. 3 by the connection between blocks 27 and 39. The control unit 202 determines the set jack-knifing angle γ_Soll using the bend curvature K and geometric characteristics (for example the axle spacing L11, the lift status S_L) and preferably an actual speed V of the vehicle train 302. In this case, the control unit 202 predicts the set jack-knifing angle γ_Soll as a forecast value of the jack-knifing angle γ that actually occurs when negotiating the bend. In alternative embodiments, the set jack-knifing angle γ_Soll can also be determined based on the trajectory T. The set jack-knifing angle γ_Soll can thus already be determined by the autonomous unit 380 and provided at the control unit 202 via the vehicle network 372. After performing the determination 39 of the set jack-knifing angle γ_Soll, the control unit 202 defines the dynamic jack-knifing angle limit γ_lim. For this purpose, the control unit 202 adds a buffer angle Δγ to the set jack-knifing angle γ_Soll and thus defines the jack-knifing angle limit (γ_lim =γ_Soll+Δγ). However, as an alternative to it being defined 41, it is also possible to provide that the jack-knifing limit value γ_lim is a static limit value with a fixed value of for example 45°.

In addition to the aforementioned influencing factors, the limitation 13 is performed in the illustrated embodiment of the method 1 also based on a prevailing coefficient of friction μ and based on the downhill gradient 368 of the road 366. A determination 45 of the prevailing coefficient of friction μ is performed prior to performing the limitation 49 of the maximum permissible continuous deceleration power LB_max additionally based on the prevailing coefficient of friction μ. In the present embodiment, the determination 45 of the prevailing coefficient of friction μ is performed using the vehicle signals SV. Thus, vehicle signals SV representing the prevailing coefficient of friction μ can be provided on the vehicle network 372, for example, by a conventional stability control system 282, which may also be referred to as an electronic stability control (ESC). Alternatively, the prevailing coefficient of friction u between the wheels 318, 324, 334 of the vehicle train 302 and the road 366 can, however, also be determined based on the rotational speeds of free-rolling wheels 318, 324, 334. A low coefficient of friction μ or a high degree of slip between the wheels 318, 324, 334 of the vehicle train 302 and the road 308 increases the risk of instabilities of the vehicle 300, so that the maximum permissible continuous deceleration power LB_max is preferably limited (limitation 49) if the coefficient of friction μ is low. Thus, the maximum permissible continuous deceleration power LB_max is preferably limited by a fixed value or relative to the determined coefficient of friction μ if the coefficient of friction μ is determined to be lower than a minimum coefficient of friction. On the other hand, if the determined coefficient of friction μ exceeds the minimum coefficient of friction, the limitation 49 based on the coefficient of friction μ can also be omitted.

Alternatively or additionally to the determination 45 of the prevailing coefficient of friction μ from the vehicle signals SV, the determination 45 can also be performed based on the slip. In the present embodiment, brake slip of the rear wheels 324a, 324b which are decelerated by the continuous deceleration device 338 can be determined by a comparison of the wheel rotational speed of the rear wheels 324a, 324b with the rotational speeds of the non-braked front wheels 318a, 318b. The rear wheels 324a, 324b are also referred to as test wheels while the front wheels 318a, 318b can also be referred to as comparison wheels. In this embodiment, a test point variable of the continuous deceleration device 338 is also determined during a time interval in which the front wheels or comparison wheels 318a, 318b roll freely and the rear wheels or test wheels 324a, 324b are decelerated by the continuous deceleration device 338. For example, a control pressure of the retarder 340 can be the test manipulated variable. In the present embodiment, the prevailing coefficient of friction μ is determined from the brake slip determined for the time interval and the associated test manipulated variable. In this case, a prevailing coefficient of friction μ that corresponds to the value pair of a brake slip and a test manipulated variable is determined from a pre-stored characteristic curve. The characteristic curve can be determined, for example, in previous test drives and pre-stored (for example in the ESC). However, it is preferably also possible to determine a slip value that is used for determining the prevailing coefficient of friction μ if normal service braking is performed.

Preferably, further parameters can also be taken into account during the determination of the prevailing coefficient of friction μ. For example, a lateral acceleration acting on the vehicle in the time interval can be determined, wherein a characteristic curve used to determine the prevailing coefficient of friction μ is selected from a plurality of pre-stored characteristic curves, taking into account the determined lateral acceleration.

Preferably, the maximum permissible continuous deceleration power can also be limited based on a determined lateral acceleration. For example, a continuous deceleration power of the continuous deceleration device 338 can be reduced in a lateral acceleration range of 1 m/s² to 2 m/s². If lateral accelerations greater than 2 m/s² occur or are expected, the continuous deceleration device 338 is preferably prevented from providing a continuous deceleration power LB or the maximum permissible permanent deceleration power LB_max is limited to zero.

The downhill gradient 368 of the road 366 is also taken into account in the method 1 during the limitation 15 of the maximum permissible continuous deceleration power LB_max. In the illustrated embodiment of the method 1, the control unit 202 thus determines the downhill gradient 368 (determination 51 in FIG. 3) using vehicle signals SV provided by the stability control system 282. Sensors of the stability control system 282, not shown in the figures, detect the downhill gradient so that the stability control system 282 can provide signals on the vehicle network 372 representing the downhill gradient 368. Subsequent to the determination 51 of the downhill gradient 368 of the road 366, a limitation 55 of the maximum permissible continuous deceleration power LB_max is performed additionally based on the determined downhill gradient 368.

Even if the limitation steps 19, 31, 35, 49, 55 in FIG. 3 are shown as separate limitations, the surrounding limitation step 13 is intended to clarify that in the illustrated example, the maximum permissible continuous deceleration power LB_max is determined simultaneously based on the mass ratio RM, the coupling length LL, the bend curvature K, the jack-knifing angle y, the coefficient of friction μ and the downhill gradient 368. Thus, the limitation 13 here is achieved by adding corresponding limits of the maximum permissible continuous deceleration power LB_max, which were determined in the context of the limitations 19, 31, 35, 49, 55. In the present example, the maximum permissible continuous deceleration power LB_max is therefore the sum of a power limitation based on the mass ratio RM, a power limitation based on the coupling length LL, a power limitation based on the bend curvature K, a power limitation based on the jack-knifing angle y and a power limitation based on the downhill gradient 368. The maximum permissible continuous deceleration power LB_max is calculated continuously in this case.

As soon as the continuous deceleration device 338 is activated, the maximum permissible continuous deceleration power LB_max is determined and the continuous deceleration power LB actually output by the continuous deceleration device 338 is limited to this value. Accordingly, if a driver of the vehicle 300 requests a continuous deceleration power LB that is greater than the maximum permissible continuous deceleration power LB_max, then the continuous deceleration device 338 provides at most the maximum permissible continuous deceleration power LB_max. If, on the other hand, the required continuous deceleration power LB is less than the maximum permissible continuous deceleration power LB_max, the continuous deceleration device 338 provides the requested continuous deceleration power LB. In the case of a lever-actuated continuous braking device 338, in which the continuous deceleration power LB is stored in discrete stages, the continuous deceleration power LB is also not further activated if the driver moves the lever to a higher continuous deceleration power LB.

Due to the limitation 13 of the maximum permissible continuous deceleration power LB, the continuous deceleration device 338 provides, where appropriate, a lower continuous deceleration power LB than is requested by the driver of the vehicle 300 and/or than is necessary in order to guide the vehicle 300 at a constant speed along the road 366 with the downward gradient 368. It is preferred that in order to compensate for this discrepancy between the required continuous deceleration power (LB_Soll) and the provided continuous deceleration power LB, a compensation deceleration power ΔLB is provided. This provision 57 of the compensating deceleration power ΔLB is also shown in FIG. 3. It is preferred that the braking system 308 of the vehicle 300 automatically applies the compensation deceleration power ALB as soon as a limit value for a deviation between the required continuous deceleration power LB_Soll and the actual continuous deceleration power LB provided is exceeded. The provision 57 of the compensation deceleration power ALB is preferably performed by activating brake actuators 316, 326, 332 of the brake system 308, which are not assigned to that axle of the vehicle 300 on which the continuous deceleration device 338 also acts. In the vehicle 300 according to FIG. 1, these are the front axle brake actuators 316, the trailer brake actuators 332 and the rear axle brake actuators 326c, 326d assigned to the lift axle 352. The driving stability of the vehicle train 302 is increased by the braking of all axles 320, 352 of the vehicle train 302, with the exception of the rear axle 350, on which the continuous deceleration device 338 acts, because a brake force distribution can be set according to the mass distribution RM.

Alternatively or additionally, a performance 63 of a trailer braking maneuver of the vehicle train 302 by means of a trailer deceleration device 384 comprising the trailer brake actuators 332, is provided in the method 1. In deviation from a brake force distribution oriented to the mass distribution RM, a purposeful trailer braking maneuver can be performed on the vehicle train 302 in a targeted manner, in which the trailer vehicle 306 realizes a larger share of the deceleration than the towing vehicle 304. Preferably, the trailer braking maneuver is performed in particular in the case of small bend radii. Furthermore, in the present embodiment of method 1, the trailer braking maneuver is only performed (performance 63 in FIG. 3) if the required continuous deceleration power LB_Soll is greater than the maximum permissible continuous deceleration power LB_max.

The control unit 202 of the driver assistance system 200 is also configured to emit a warning signal W if the maximum permissible continuous deceleration power LB_max is lower than the technically possible continuous deceleration power LB_tech of the continuous deceleration device 338. This emission 67 of a warning signal W is illustrated in method 1 according to FIG. 3. In this way, a human or virtual driver (for example of the autonomous unit 380) is optionally but not necessarily given an indication that the continuous deceleration power LB_Soll requested by them is not being provided by the continuous deceleration device 338 and that a redistribution to the service brake is taking place or should take place. This enables the driver to learn how to operate and control the continuous deceleration device 338 and to adapt their driving style and operating method in comparable driving situations. The emission 67 can be performed visually via a lamp, acoustically, haptically and/or digitally. Thus, for example, the control unit 202 of the driver assistance system 200 can provide the warning signal W on the vehicle network 372 so that the warning signal W can be received by the autonomous unit 380 of the vehicle 300.

It is understood that the foregoing description is that of the preferred embodiments of the invention and that various changes and modifications may be made thereto without departing from the spirit and scope of the invention as defined in the appended claims.

### REFERENCE CHARACTERS (PART OF THE DESCRIPTION)

1 Method
5 Determination of a trailer mass
7 Determination of a towing vehicle mass
9 Determination of a mass ratio
13 Limitation of a maximum permissible continuous deceleration power
15 Determination of a coupling length
19 Limitation of a maximum permissible continuous deceleration power additionally based on the coupling length
21 Determination of a lift status
23 Determination of a position of an axle group center
27 Determination of a bend curvature
31 Limitation of a maximum permissible continuous deceleration power additionally based on the bend curvature
33 Determination of a jack-knifing angle
35 Limitation of a maximum permissible continuous deceleration power additionally based on a jack-knifing angle
39 Determination of a set jack-knifing angle
41 Defining a dynamic jack-knifing angle limit value
45 Determination of a prevailing coefficient of friction
49 Limitation of a maximum permissible continuous deceleration power additionally based on the coefficient of friction
51 Determination of a downhill gradient
55 Limitation of a maximum permissible continuous deceleration power additionally based on the downhill gradient
57 Provision of a compensation deceleration power
63 Performance of a trailer braking maneuver
67 Emission of a warning signal
200 Driver assistance system
202 Control unit
204 Interface
300 Vehicle
301 Prevailing vehicle configuration
302 Vehicle train
304 Towing vehicle
306 Trailer vehicle
308 Braking system
310 Front axle brake circuit
312 Rear axle brake circuit
314 Trailer brake circuit
316, 316a, 316b Front axle brake actuators
318a, 318b Front wheels
320 Front axle
322 Rear axle group
324, 324a, 324b,
324c, 324d Rear wheels
326, 326c, 326d Rear axle brake actuator
328c, 328d Service brake part
330c, 330d Spring storage part
332, 332a, 332b,
332c, 332d Trailer brake actuator
334a, 334b,
334c, 334d Trailer wheels
336 Brake modulator
338 Continuous deceleration device
340 Retarder
342 Actuating lever
344 Lorry
346 Towing bar trailer
348 Towing bar
350 Rear axle
352 Liftable additional axle, lift axle
354 First load area
356 Second load area
358 First load
360 Second load
362 Towing vehicle center of gravity
364 Trailer vehicle center of gravity
366 Road
368 Downhill gradient
370 Coupling
372 Vehicle network
374 Lever arm
376 Axle group center
378 Coupling point
380 Autonomous unit
382 Stability control system
384 Trailer deceleration device
ECU Main control unit
ECU2 Trailer control unit
F Coupling force
K Bend curvature
LB Continuous deceleration power
LB_max Maximum permissible continuous deceleration power
LB_Soll Required continuous deceleration power
LB_tech Technically possible continuous deceleration power
LL Coupling length
L11 Axle spacing
L12 Lift axle spacing
L13 Coupling spacing
m1 Towing vehicle mass
m2 Trailer mass
m_ges Total vehicle mass
RM Mass ratio
STR Trailer signals
SV Vehicle signals
S_L Lift status
T Trajectory
V Speed
W Warning signal
γ Jack-knifing angle
γ_lim Jack-knifing angle limit value
γ_Soll Set jack-knifing angle
ALB Compensation deceleration power
Δγ Buffer angle
μ Coefficient of friction

1. A method for controlling a vehicle train having a towing vehicle and at least one trailer vehicle, wherein the towing vehicle includes a continuous deceleration device for performing a continuous deceleration, the method comprising:
determining a trailer mass of the at least one trailer vehicle in a prevailing vehicle configuration of the vehicle train;
determining a towing vehicle trailer mass of the towing vehicle in the prevailing vehicle configuration;
determining a mass ratio of the prevailing vehicle configuration based on the trailer mass and the towing vehicle mass; and,
limiting a maximum permissible continuous deceleration power of the continuous deceleration device based on the mass ratio.

2. The method of claim 1, wherein the maximum permissible continuous deceleration power is reduced with an increasing relative proportion of the trailer mass to a total mass of the vehicle train.

3. The method of claim 1 further comprising:
determining a coupling length for a coupling force which acts during an operation of the vehicle train between the towing vehicle and the at least one trailer vehicle; and,
limiting the maximum permissible continuous deceleration power of the continuous deceleration device additionally based on the coupling length.

4. The method of claim 3, wherein the maximum permissible continuous deceleration power is increasingly limited with an increasing coupling length.

5. The method of claim 3, wherein said determining the coupling length includes:
determining a lift status of a lift axle of the towing vehicle;
determining a trailer type of the at least one trailer vehicle;
determining a coupling point via a trailer type;
determining a rear-most axle of the towing vehicle in a travel direction; and,
determining the coupling length as a spacing between the rear-most axle in a travel direction and the coupling point of the towing vehicle, wherein the spacing is determined in a vehicle longitudinal direction.

6. The method of claim 1 further comprising:
determining a bend curvature of a road to be driven on by the vehicle train; and,
limiting the maximum permissible continuous deceleration power of the continuous deceleration device additionally based on the determined bend curvature.

7. The method of claim 1 further comprising:
determining a jack-knifing angle between the towing vehicle and the at least one trailer vehicle; and, limiting the maximum permissible continuous deceleration power of the continuous deceleration device if the jack-knifing angle exceeds a jack-knifing angle limit value.

8. The method of claim 7 further comprising:
determining a set jack-knifing angle between the towing vehicle and the at least one trailer vehicle; and,
defining the jack-knifing angle limit value as a dynamic jack-knifing limit value, which corresponds to the set jack-knifing angle plus a buffer angle.

9. The method of claim 1 further comprising:
determining a prevailing coefficient of friction for the vehicle train; and,
limiting the maximum permissible continuous deceleration power of the continuous deceleration device additionally based on the prevailing coefficient of friction.

10. The method of claim 1 further comprising:
determining a downhill gradient of a road to be driven on by the vehicle train; and,
limiting the maximum permissible continuous deceleration power of the continuous deceleration device additionally based on the determined downhill gradient.

11. The method of claim 1 further comprising providing a compensation deceleration power at one of multiple axles of the vehicle train, which are independent of the continuous deceleration device, in order to at least partially compensate for an incorrect deceleration power caused by the limitation of the maximum permissible continuous deceleration power of the continuous deceleration device.

11. The method of claim 1 further comprising:
performing a trailer braking maneuver of the vehicle train via a trailer deceleration device of the at least one trailer vehicle if a continuous deceleration power required for the vehicle train is greater than the maximum permissible continuous deceleration power.

12. The method of claim 1 further comprising emitting a warning signal if the maximum permissible continuous deceleration power is less than a technically possible continuous deceleration power of the continuous deceleration device.

13. A driver assistance system for a commercial vehicle, the driver assistance system being configured so as to perform the method of claim 1.

14. A commercial vehicle comprising:
a continuous deceleration device;
a driver assistance system including a processor and a non-transitory computer readable medium having program code stored thereon;
said program code being configured, when executed by said processor, to:
determine a trailer mass of at least one trailer vehicle in a prevailing vehicle configuration of a vehicle train;
determine a towing vehicle trailer mass of a towing vehicle in the prevailing vehicle configuration;
determine a mass ratio of the prevailing vehicle configuration based on the trailer mass and the towing vehicle mass; and,
limit a maximum permissible continuous deceleration power of the continuous deceleration device based on the mass ratio.

15. A computer program product comprising program code stored on a non-transitory computer-readable data carrier, the program code being configured, when executed by a processor, to:
determine a trailer mass of at least one trailer vehicle in a prevailing vehicle configuration of a vehicle train;
determine a towing vehicle trailer mass of a towing vehicle in the prevailing vehicle configuration;
determine a mass ratio of the prevailing vehicle configuration based on the trailer mass and the towing vehicle mass; and,
limit a maximum permissible continuous deceleration power of the continuous deceleration device based on the mass ratio.
